(19) United States
(12) Patent Application Publication
(10) Pub. No.: US 2009/0292469 A1
(43) Pub. Date: Nov. 26, 2009

(54) PORTABLE APPARATUS FOR STORING TASTE AND ODOR

(76) Inventors: Ji-Yeon Son, Daejon (KR); Yong-Hee Lee, Daejon (KR); Myung-Gyu Kim, Daejon (KR); Il-Sik Yang, Daejon (KR); Jun-Seok Park, Daejon (KR); Dong-Won Han, Daejon (KR)

Correspondence Address: LADAS & PARRY LLP, 224 SOUTH MICHIGAN AVENUE, SUITE 1600, CHICAGO, IL, 60604, US

(21) Appl. No.: 12/375,820

(22) PCT Filed: Mar. 6, 2007
(86) PCT No.: PCT/KR07/01093

§ 371 Date: Jan. 30, 2009

(30) Foreign Application Priority Data
Aug. 2, 2006 (KR) 10-2006-0072998

(51) Int. Cl. G06F 19/00; G06F 15/00

(52) U.S. Cl. 702/1; 702/187

(57) ABSTRACT

Provided is a portable apparatus for recognizing and storing taste/odor, and a method thereof. The apparatus, includes: a sensor for recognizing taste/odor information by using at least one sensor and modulating the taste/odor information into an electrical signal; a control unit for transforming the recognized taste/odor information into a standardized format to record the taste/odor information in a storage; a storage for storing the standardized taste/odor information by control of the control unit; an input/output interface for transmitting the stored taste/odor information to outside; and a power source for supplying power to each constituent element.

### TECHNICAL FIELD

The present invention relates to a portable apparatus for recognizing and storing taste/odor, and a method thereof; and, more particularly, to a portable taste/odor storing apparatus which can recognize taste/odor by using at least one sensor, store recognized taste/odor information in a storage where data can be written and read in a standardized format, and transmit the recognized taste/odor information to an external device, and a method thereof.

### BACKGROUND ART

As computer and network technologies are developed recently, digital contents have been generalized. Therefore, methods for storing moving picture, image, or sound existing in a real world in a digitalized format and digital storing devices are largely commercialized as products. As representative examples, there are a digital camera, a digital camcoder, and a voice recorder. Users store memorable scenes or sights in the real world in the digital storing devices and apply the digital storing devices to restore or print the memorable scenes or sights as a picture. When users store new taste/odor in a similar format, a portable device for storing taste/odor such as a camera or a camcoder is required. Products for electronically recognizing and analyzing taste/odor based on a current sensor technology such as an electronic tongue or an electronic nose are not generalized, but limitedly applied to food control or quality control for industrial use. The electronic tongue or electronic nose products provide a function for modulating a chemical signal into an electrical signal by using sensors and analyzing taste based on pattern recognizing software.

If taste/odor components recognized by a sensor can be stored in a readable and writable standardized format, it is also possible to analyze and apply the taste by transmitting the stored taste/odor information to an individual device, which is in charge of analyzing a taste/odor pattern. The pattern analyzing procedure generally requires highly efficient quality in a Central Processing Unit (CPU) process and a storing space. Accordingly, when the pattern analyzing procedure is performed in an individual device, the taste/odor storing device can be manufactured in a format, which is much lighter and easier to carry.

With the apparatus of the present invention, the user can recognize and store taste/odor information while moving, and apply the taste/odor information by transmitting the taste/odor information through an interface with an external device.

### DISCLOSURE OF INVENTION

### Technical Problem

It is, therefore, an object of the present invention to provide a portable taste/odor storing apparatus which can recognize taste/odor by using at least one sensor, store recognized taste/odor information in a storage where data can be written and read in a standardized format, and transmit the recognized taste/odor information to an external device, and a method thereof.

Other objects and advantages of the invention will be understood by the following description and become more apparent from the embodiments in accordance with the present invention, which are set forth hereinafter. It will be also apparent that objects and advantages of the invention can be embodied easily by the means defined in claims and combinations thereof.

### Technical Solution

In accordance with one aspect of the present invention, there is provided a portable taste/odor storing apparatus, including: a sensor for recognizing taste/odor information by using at least one sensor and modulating the taste/odor information into an electrical signal; a control unit for transforming the recognized taste/odor information into a standardized format to record the taste/odor information in a storage; a storage for storing the standardized taste/odor information by control of the control unit; an input/output interface for transmitting the stored taste/odor information to outside; and a power source for supplying power to each constituent element.

In accordance with another aspect of the present invention, there is provided a method for storing taste/odor, including the steps of: a) recognizing a taste/odor component by using at least one sensor and modulating the taste/odor component into an electrical signal; b) transforming the recognized taste/odor information into a standardized format; c) storing the standardized taste/odor information; and d) transmitting the stored taste/odor information to outside through interface with outside.

### Advantageous Effects

The apparatus of the present invention recognizes taste/odor by using at least one sensor, store recognized taste/odor information in a standardized format in a readable and writable storage, and transmits the recognized taste/odor information to an external device. Accordingly, a user can store the taste/odor information of an object, which is preferred by the user, analyze and reproduce the stored taste/odor information by transmitting the taste/odor information to the external device.

### BRIEF DESCRIPTION OF THE DRAWINGS

The above and other objects and features of the present invention will become apparent from the following description of the preferred embodiments given in conjunction with the accompanying drawings, in which:

FIG. 1 is a block diagram showing a portable taste/odor storing apparatus in accordance with an embodiment of the present invention;

FIG. 2 is a flowchart describing a portable taste/odor storing method in accordance with an embodiment of the present invention; and

FIG. 3 shows an exemplary syntax of the taste/odor information recorded in the storage in the inside of the portable taste/odor storing apparatus in accordance with an embodiment of the present invention.

### BEST MODE FOR CARRYING OUT THE INVENTION

Other objects and advantages of the present invention will become apparent from the following description of the embodiments with reference to the accompanying drawings. Therefore, those skilled in the field of this art of the present invention can embody the technological concept and scope of the invention easily. In addition, if it is considered that detailed description on a related art may obscure the points of the present invention, the detailed description will not be provided herein. The preferred embodiments of the present invention will be described in detail hereinafter with reference to the attached drawings.

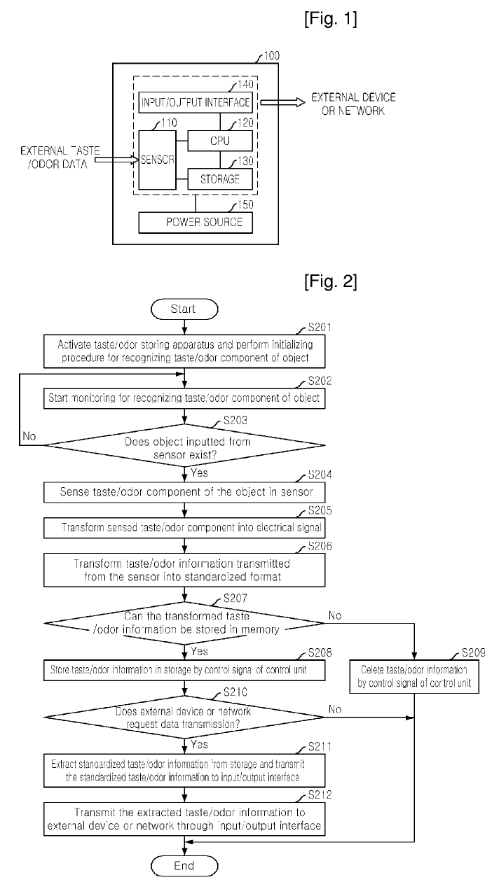

FIG. 1 is a block diagram showing a portable taste/odor storing apparatus in accordance with an embodiment of the present invention. The portable taste/odor storing apparatus 100 includes a sensor 110, a Central Processing Unit (CPU) 120, a storage 130, an input/output interface 140 and a power source 150.

The sensor 110 recognizes taste/odor information by using at least one sensor and modulates the taste/odor information into an electrical signal. The CPU 120 transforms the taste/odor information recognized in the sensor 110 into a standardized format to record the taste/odor information in the storage 130. The storage 130 stores the standardized taste/odor information by control of the CPU 120 as readable and writable recording media. The input/output interface 140 transmits the taste/odor information stored in the storage 130 to an external device or a network by control of the CPU 120. The power source 150 supplies power to each constituent element.

Each constituent element will be described in detail hereinafter.

The sensor 110 included in the portable taste/odor storing apparatus includes at least one sensor for recognizing an object having taste/odor, recognizes a taste/odor component from an object of a liquid or gas phase, transforms and outputs the taste/odor component into an electric digital signal. That is, the sensor 110 transforms the chemical component of the taste/odor from the object into the electrical signal by the sensor for recognizing taste/odor.

Meanwhile, information or data additionally sensed by the sensor 110 may include information or data recognized correspondingly to reaction. That is, environmental information or data as well as information on taste/odor may be included through a sensor, which can measure a neighboring environment such as temperature or strength of the object.

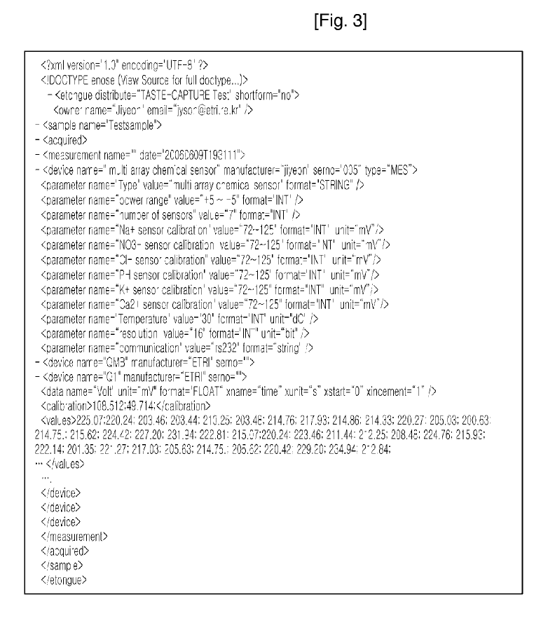

The CPU 120 performs an entire control function of each constituent element of the portable taste/odor storing apparatus 100, transforms the taste/odor information of an electrical signal format transmitted from the sensor 110 into a predetermined standardized format for storing the taste/odor information (see FIG. 3), and stores the transformed taste/odor information in the storage 130. Subsequently, the CPU 120 extracts and transmits the taste/odor information from the storage 130 upon request of the taste/odor information through the input/output interface 140.

The storage 130 can be realized based on an embedded memory or a portable memory, which is readable and writable by the CPU 120, such as a Multi-Media Card (MMC), a compact flash (CF), a smart media card (SMC), a secure digital (SD) card, a memory stick, or an xD picture card. The storage 130 includes a storage for storing the taste/odor information recognized by the sensor 110.

Serial or parallel Interface devices, which can transmit taste/odor information to an external device or a network, universal serial bus (USB) or a wired/wireless communication interface, can be used as the input/output interface 140. There are Bluetooth, wired/wireless Local Area Network (LAN), Zigbee, near field communication (NFC), Radio Frequency Identification (RFID) tag, wireless broadband (WiBro), Code Division Multiple Access (CDMA), and Global System for Mobile Communications (GSM) as an example of the wired/wireless communication interface. When the portable taste/odor storing apparatus 100 is connected with the external device or the network through wireless communication, the input/output interface 140 is recognized by the sensor 110, or modulates the taste/odor information pre-stored in the storage 130 by control of the CPU 120 into a radio frequency signal and transmits the radio frequency signal to the external device or the network.

FIG. 2 is a flowchart describing a portable taste/odor storing method in accordance with an embodiment of the present invention. FIG. 2 shows a sensing procedure for recognizing a taste/odor component of an object by using at least one sensor and modulating the taste/odor component into an electrical signal, a transform procedure for transforming the taste/odor information recognized in the sensing procedure into a standardized format, a storing procedure for storing the standardized taste/odor information, which is transformed in the transform procedure, and a transmitting procedure for transmitting the stored taste/odor information to outside through interface with an external device.

The above procedures will be described in detail with reference to FIG. 2.

When the portable taste/odor storing apparatus 100 receives power from the power source 150 and is activated, the portable taste/odor storing apparatus 100 performs an initializing procedure for recognizing a taste/odor component of an object at step S201. Subsequently, the portable taste/odor storing apparatus 100 starts monitoring for recognizing the taste/odor component of the object at step S202. The monitoring procedure for the object is continued until the portable taste/odor storing apparatus 100 is deactivated. That is, it is determined at step S203 whether the object inputted from the sensor 110 exists and repeats the monitoring procedure of step S202 in case that the object inputted from the sensor 110 does not exist. When the object inputted from the sensor 110 exists, the sensor 110 senses the taste/odor component of the object at step S204 and transforms the sensed taste/odor component into an electrical signal at step S205.

The CPU 120 transforms the electric digital signal for the taste/odor information transmitted from the sensor 110 into a standardized format for storing the electric digital signal in the storage at step S206.

It is determined at step S207 whether the transformed taste/odor information can be stored in the memory. When the transformed taste/odor information can be stored in the memory, the standardized taste/odor information is stored in the storage 130 at step S208. When the transformed taste/odor information cannot be stored in the memory, the taste/odor information is deleted and the logic flow ends at step S209.

The CPU 120 determines at step S210 whether the external device or the network requests data transmission on the stored taste/odor information. When the data transmission is not requested, the logic flow ends. Otherwise, the CPU 120 extracts the standardized taste/odor information from the storage 130 and transmits the standardized taste/odor information to the input/output interface 140 at step S211.

The input/output interface 140 transmits the transmitted taste/odor information to the external device or the network at step S212. The external device may be a terminal or a device for processing the standardized taste/odor information. The network may be the network of the wired/wireless communication method supported by the input/output interface 140.

FIG. 3 shows an exemplary syntax of the taste/odor information recorded in the storage in the inside of the portable taste/odor storing apparatus in accordance with an embodiment of the present invention.

The taste/odor information stored in the storage 130 of the portable taste/odor storing apparatus 100 includes information on an attribute of the sensors and the taste/odor storing apparatus and information on measured real values of the object. The taste/odor information may include information on strength, temperature, and pH of the object. As an example of the attribute of the included sensors, there are a kind of sensor, identification, a manufacturer, a model, a serial number, the number of sensors, a maximum value and a minimum value of a measurement signal, a unit of an output signal, supply voltage and a current size.

As described above, the technology of the present invention can be realized as a program and stored in computer-readable recording media, such as CD-ROM, RAM, ROM, floppy disk, hard disk and magneto-optical disk. Since the process can be easily implemented by those skilled in the art, further description will not be provided herein.

The present application contains subject matter related to Korean patent application No. 2006-0072998, filed in the Korean Intellectual Property Office on Aug. 2, 2006, the entire contents of which are incorporated herein by reference.

While the present invention has been described with respect to certain preferred embodiments, it will be apparent to those skilled in the art that various changes and modifications may be made without departing from the scope of the invention as defined in the following claims.

1. A portable taste/odor storing apparatus, comprising:
a sensor for recognizing taste/odor information by using at least one sensor and modulating the taste/odor information into an electrical signal;
a control unit for transforming the recognized taste/odor information into a standardized format to record the taste/odor information in a storage;
a storage for storing the standardized taste/odor information by control of the control unit;
an input/output interface for transmitting the stored taste/odor information to outside; and
a power source for supplying power to each constituent element.

2. The apparatus as recited in claim 1, wherein the control unit performs an entire control function on each constituent element, transforms the taste/odor information of the electrical signal format transmitted from the sensor into a pre-determined standardized format for storing the taste/odor information, stores the transformed taste/odor information in the storage, extracts corresponding taste/odor information from the storage upon request of the taste/odor information through the input/output interface, and transmits the taste/odor information.

3. The apparatus as recited in claim 1, wherein the storage stores information on a taste/odor storing apparatus, attributes of the sensors, information on measured real values of the object, and information on strength, temperature, and pH of the object.

4. A method for storing taste/odor, comprising the steps of:
a) recognizing a taste/odor component by using at least one sensor and modulating the taste/odor component into an electrical signal;
b) transforming the recognized taste/odor information into a standardized format;
c) storing the standardized taste/odor information; and
d) transmitting the stored taste/odor information to outside through interface with outside.

5. The method as recited in claim 4, further comprising the step of:
e) when the standardized taste/odor information cannot be stored, deleting corresponding taste/odor information.
